(19) United States
(12) Patent Application Publication
(10) Pub. No.: US 2016/0314532 A1
(43) Pub. Date: Oct. 27, 2016

(54) System for Determining Margin Requirements

(71) Applicant: Chicago Mercantile Exchange Inc., Chicago, IL (US)

(72) Inventors: Jingbin Yin, Naperville, IL (US); Jalpan Shah, Chicago, IL (US)

(21) Appl. No.: 15/002,627

(22) Filed: Jan. 21, 2016

Related U.S. Application Data
(60) Provisional application No. 62/108,282, filed on Jan. 27, 2015.

(51) Int. Cl. G06Q 40/06; G06Q 40/04

(52) U.S. Cl. CPC G06Q 40/06; G06Q 40/04

(57) ABSTRACT

Systems and methods are provided for determining volatility levels and margin requirements for portfolios that include swaptions. End of day volatility data from swaption dealers. The data may be filtered and blended to obtain data and then a modified SABR model may be used to fit a smile to the data points. The modified SABR model models density instead of implied volatility

The present application claims priority to U.S. provisional patent application Ser. No. 62/108,282, filed Jan. 27, 2015, the entire disclosure of which is hereby incorporated by reference.

### FIELD OF THE INVENTION

Embodiments of the present invention relate to systems and methods for processing data. More particularly, the invention provides mechanisms for determining pricing, volatility and margin requirements.

### DESCRIPTION OF THE RELATED ART

A swaption is an option to enter into an interest rate swap. In exchange for an option premium, the buyer gains the right but not the obligation to enter into a specified swap agreement with the issuer on a specified future date. Exemplary swaps are interest rate swaps. Trades involving swaptions are typically large but occur infrequently and may have nonstandard terms. Clearinghouses and other entities that clear trades require traders, such as traders of swaptions, to maintain performance bonds in margin accounts to cover risks associated with the portfolios. The clearinghouse (e.g., central counterparty to financial products) may use the performance bond to counter market risk and liquidity risk associated with the portfolio. Risks are analyzed to determine required initial margin amounts and maintenance margin amounts. A risk calculation module (or risk processor) may assist in the calculation. In some examples, values (e.g., swap DV01s, volatility values, etc.) and adjustments/factors (e.g., calendar charge adjustments, liquidity charges, etc.) may be used to enhance the margin calculation.

Clearinghouses are structured to provide exchanges and other trading entities with solid financial footing. Maintaining proper margin amounts is an important part of the maintaining solid financial footing. The required margin amount generally varies according to the volatility of a financial instrument; the more volatility, the larger the required margin amount. This is to ensure that the bond will cover maximum losses that a contract would likely incur over a given time period, such as a single day. Required margin amounts may be reduced where traders hold opposite positions in closely correlated markets or spread trades.

Calculating margin amounts can be a challenge, even when computer devices are utilized. In the trading environment the speed with which information can be determined and distributed to market participants can be critical. For example, regulations set time limits for clearing entities to provide margin requirements to market participants after the end of a trading day. Some market participants also expect clearing entities to quickly determine how a potential transaction will impact their margin requirements.

As the numbers of accounts and transactions increase it becomes difficult for existing computer systems and processes to determine and communicate pricing, volatility and margin requirements to market participants in the time frames required by regulations or expected by the market participants. Therefore there is a need in the art for more efficient computer systems and computer-implemented methods for determining and communicating pricing, volatility and margin requirements to market participants.

### SUMMARY OF THE INVENTION

Embodiments of the present invention provide efficient computer systems and computer-implemented methods for determining and communicating pricing, volatility and margin requirements to market participants. In some embodiments, computer-implemented methods are adapted to efficiently use computer resources so that pricing, volatility and/or margin requirement determination can be performed quickly and efficiently with computer devices. Various embodiments of the invention include computer devices that receive end of day volatility data from swaption dealers. The data may be filtered, blended and/or interpolated to obtain data and then a modified SABR model may be used to fit a smile to the data points. The modified SABR model may model density instead of implied volatility.

In some embodiments of the invention the modified SABR model uses an implied parameter to cause the volatility smile to pass through average values of the end of day volatility data.

In various embodiments, the present invention can be partially or wholly implemented on a computer-readable medium, for example, by storing computer-executable instructions or modules, or by utilizing computer-readable data structures.

Of course, the methods and systems disclosed herein may also include other additional elements, steps, computer-executable instructions, or computer-readable data structures. The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention.

FIG. 2 illustrates a conventional volatility smile that shows the relationship between strike prices and volatility for options contracts, such as swaptions.

FIG. 3 illustrates a method that may be used to determine volatility levels of swaptions in accordance with an embodiment of the invention.

FIG. 4 illustrates an exemplary volatility smile created with a modified SABR model.

FIG. 5 illustrates a method that may be used to determine volatility levels of swaptions in accordance with an embodiment of the invention.

FIG. 6 illustrates an exemplary method for determining margin requirements in accordance with an embodiment of the invention.

FIG. 7 illustrates a continuation of the method started in FIG. 6.

FIG. 8 illustrates a method that may be used to determine volatility levels of swaptions, in accordance with an embodiment of the invention.

FIG. 9 show exemplary low t=values, in accordance with an embodiment of the invention.

FIG. 10 shows the extreme fluctuation in ρ in response low ν values, in accordance with an embodiment of the invention.

FIG. 11 shows the effective of ν₁ on the slope of the implied volatility, in accordance with an embodiment of the invention.

FIG. 12 shows the impact of changing ν₂ on the curvature, in accordance with an embodiment of the invention.

FIG. 13 illustrates an exemplary volatility smile created with the process shown in FIG. 8.

FIG. 14 illustrates a cumulative probability density function in accordance with an embodiment of the invention.

FIG. 15 illustrates a process that may be used to calculate a valuation uncertainty margin, in accordance with an embodiment of the invention.

FIG. 16 shows the relationship between skew parameters, in accordance with an embodiment of the invention.

### DETAILED DESCRIPTION OF THE INVENTION

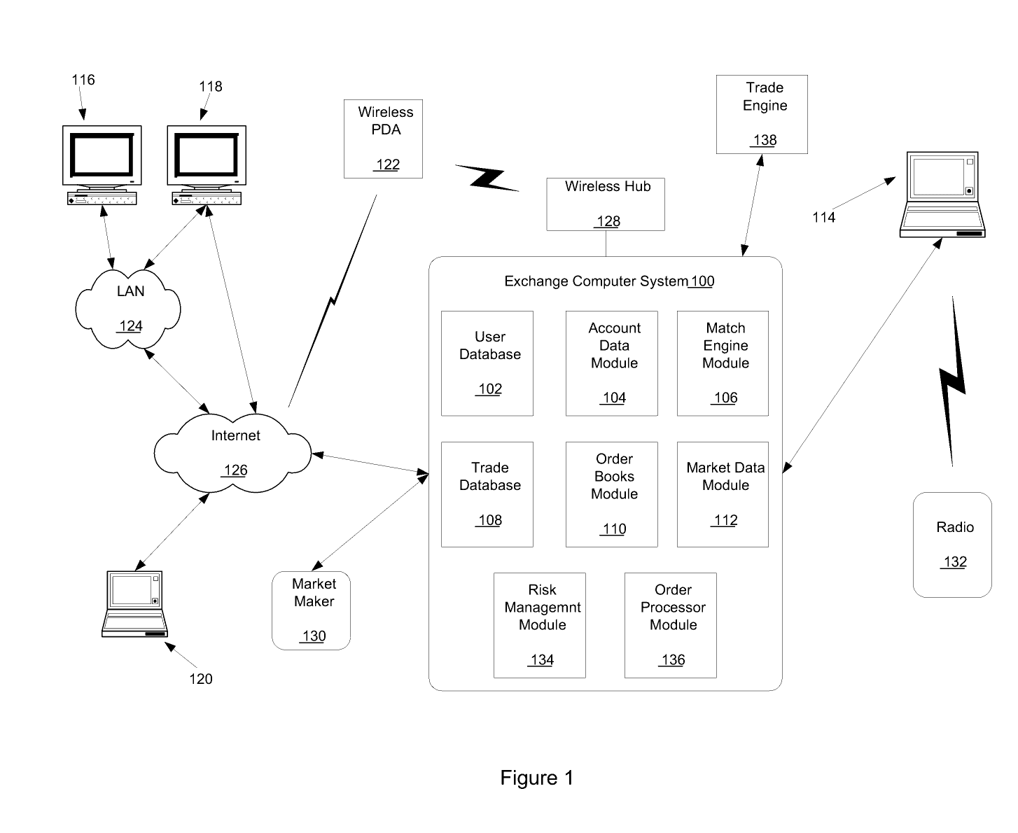

Aspects of the present invention may be implemented with computer devices and computer networks that allow users to exchange trading information. An exemplary trading network environment for implementing trading systems and methods is shown in FIG. 1.

An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

In one alternative embodiment, a clearinghouse computer or computer system may be included. A clearinghouse or other entity that clears trades may use a clearinghouse computer or computer system to accurately calculate swaption settlement prices, values, risk and margin requirements.

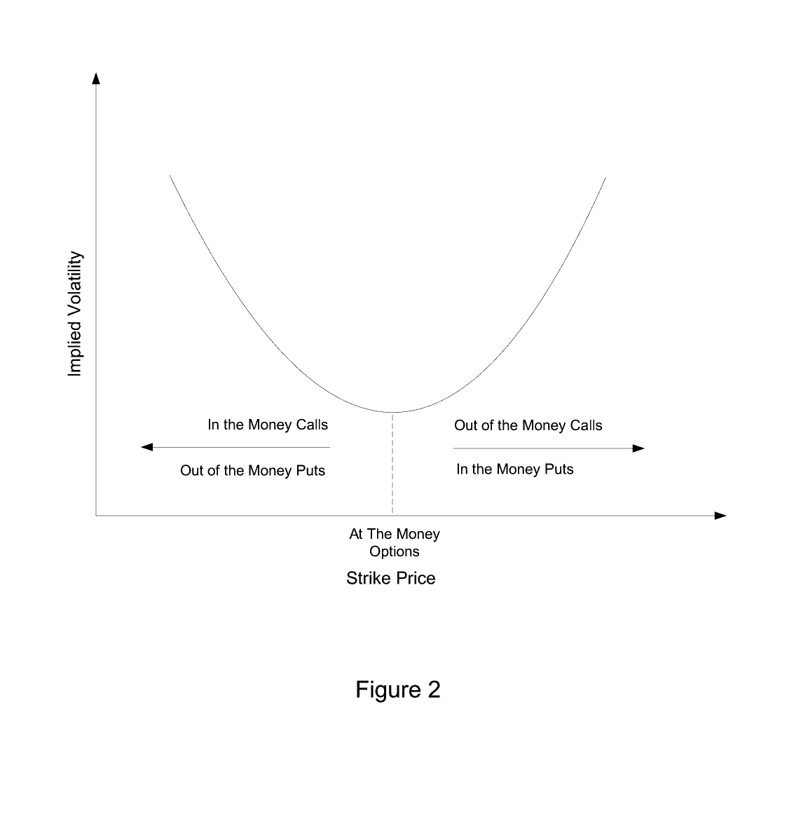

FIG. 2 illustrates a conventional volatility smile that shows the relationship between strike prices and volatility for options contracts, such as swaptions. As is shown in FIG. 2, the more an option is in-the-money or out-of-the-money, the greater its implied volatility may differ from the ATM option. Implied volatility of an option contract, such as a swaption may be related to a price of an option with an option pricing model, such as the Black-Scholes model. The SABR model is a stochastic volatility model, which attempts to capture the volatility smile in derivatives markets. The name SABR stands for “stochastic α, β, ν, ρ”, which are the parameters of the model.

In accordance with various embodiments of the invention methods of determining volatility levels for swaptions are provided. The volatility levels may be determined by first receiving some end of day volatility data from swap option dealers and then using one or more volatility models to interpolate missing data. One model may fit the data more strictly than another model. The model chosen may be a function of the use of the model. For example, when performing a mark to market process a model that strictly fits data may be used and when performing a margin requirement determination a model that less strictly fits data may be used.

In at least some embodiments of the invention, a model may be chosen or optimized to cause a computer device, such as exchange computer system 100 or a clearinghouse computer system, to determine and communicate pricing, volatility and margin requirements to market participants in the time frames required by regulations or expected by the market participants. All computer devices, such as exchange computer 100 and clearinghouse computer systems have limited processing capabilities. Some computer-implemented algorithms may use interpolation, data filtering or other steps to allow a computer device programmed with one of the computer-implemented algorithms to efficiently and quickly determine and communicate pricing, volatility and margin requirements.

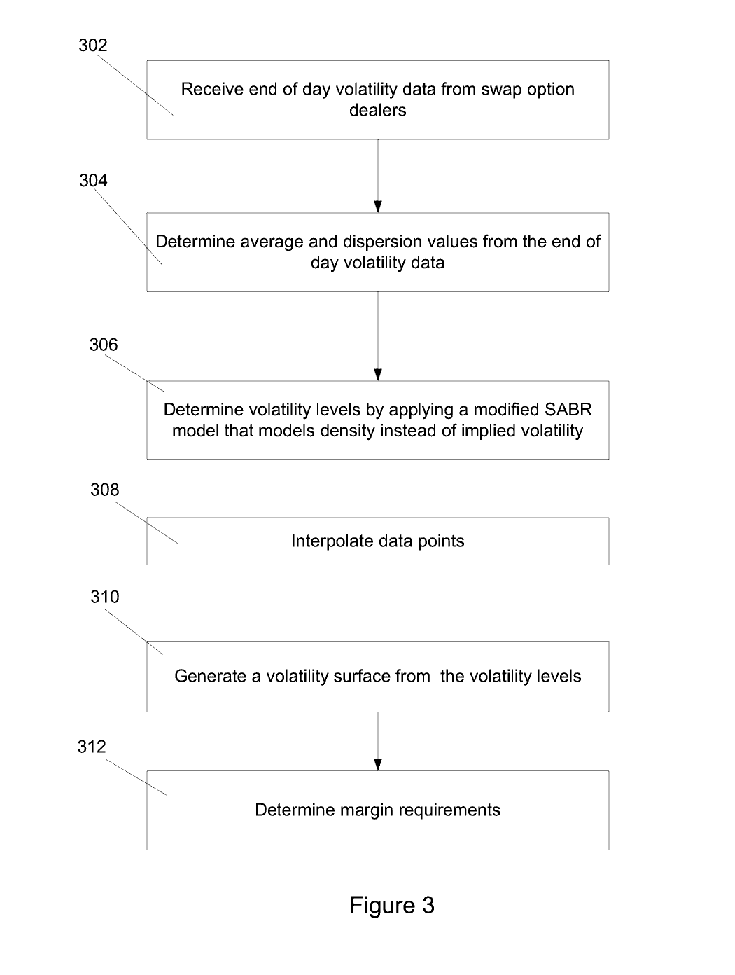

FIG. 3 illustrates a method that may be used to determine volatility levels of swaptions in accordance with an embodiment of the invention. The volatility levels may be used to determine prices and margin requirements. First, in step 302 end of day volatility data is received from swaption dealers. In some embodiments the data may be received from sources in addition to or instead of swaption dealers. The end of day volatility data may include data for swaptions having multiple expiry, tenor and moneyness. The data may include skew normal/log-normal volatility, and prices. Alternative embodiments of the invention may use data determined at times other than end of day.

After the volatility data is received, in step 304 average and dispersion values from the end of day price data may be determined. Step 304 may include blending data received from multiple sources at multiple strike prices. Blending the data prevents outlier data from having an undue influence on the data. In some embodiments the volatility data may be used instead of price data.

Next, in step 306 volatility levels may be determined by applying a modified SABR model that models density instead of implied volatility. The modified SABR model may weight each moneyness with a weight inversely proportional to the dispersion of data received from the swaption dealers. The modified SABR model may be used to fit a smile curve to mid-market values.

One particular modified SABR model for determining volatility is provided below:

$$\{ \begin{matrix}dF = z \cdot σ ( F ) \cdot d {ω}_{1} \\ dz = v \cdot z \cdot d {ω}_{2}\end{matrix} \\ where F ( 0 ) = {F}_{0} , z ( 0 ) = 1 , 〈 d {ω}_{1} , d {ω}_{2} 〉 = ρ dt , σ ( F ) = α {F}^{β} .$$

F is underlying
Z is level of volatility
α=initial volatility
ω₁ and ω₁=Brownian noises
β=skewness parameter

One particular modified SABR model for determining volatility is provided below. The “odd power” pow(X;α)=|X|^{α}·sign(X) to simplify the notation. Then

$$y ( X ) = \frac{1}{2 v} [ ( 1 + ρ ) {e}^{Xv} - 2 ρ - ( 1 - ρ ) {e}^{- Xv} ] \\ F ( y ) = C \cdot pow ( pow ( {F}_{0} , 1 - β ) + α \cdot ( 1 - β ) \cdot y ) , \frac{1}{1 - β} )$$

$$p ( X ) = \frac{1}{\sqrt{2 π T}} exp ( - \frac{{X}^{2}}{2 T} )$$

$$Call option = {\int }_{- ∞}^{∞} d Xp ( X ) \cdot max ( F ( y ( X ) ) - K , 0 )$$

$$where C is determined from the condition$$

$${F}_{0} = \int p ( X ) F ( y ( X ) ) d X$$

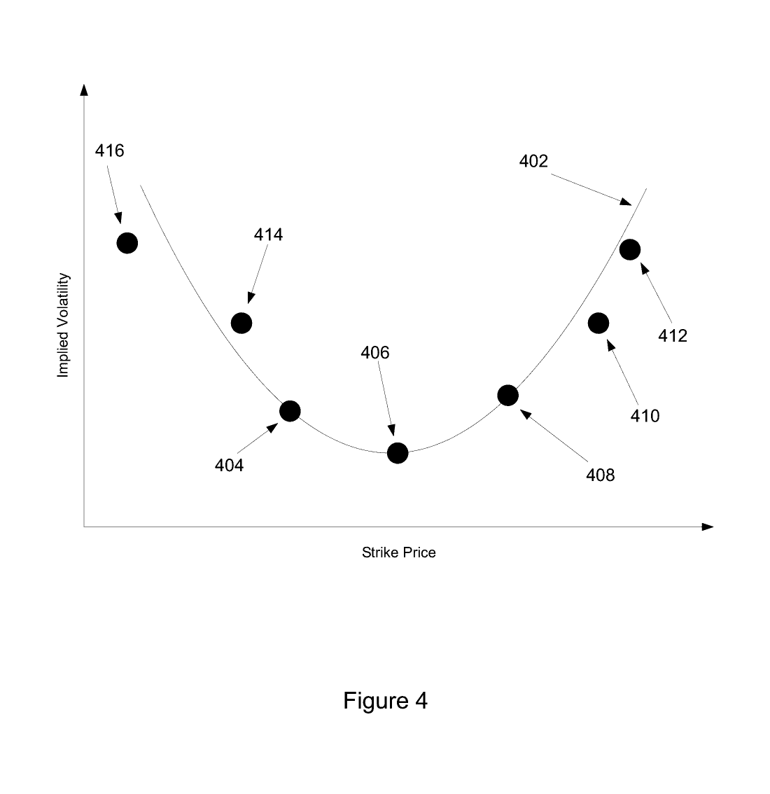

FIG. 4 illustrates an exemplary volatility smile 402 created with a modified SABR model. Points 404-416 represent average or blended data points received from swaption dealers or other sources. The modified SABR model has three degrees of freedom that allows smile 402 to hit three points relatively close to one another 404, 406 and 408. Smile 402 is close to, but does not hit the remaining points.

In step 308, interpolation between volatility data points may be performed. A clearinghouse computer system may use linear interpolation, or other interpolation on parameters to generate the parameters for pairs between the most liquid tenor/expiry points. The use of interpolation may increase the speed at which a computer device can perform calculations. In some embodiments a clearinghouse computer system may also perform linear interpolation or other interpolation on variance of the parameters.

Once the volatility levels have been determined, a volatility surface may be generated in step 310. Of course, multiple surfaces may be created or the volatility levels may be used to create other types of charts or may be used in other calculations.

In step 312, volatility levels may be used to determine margin account requirements.

The margin account requirements may be initial margin account requirements and/or maintenance margin account requirements.

Aspects of a modified SABR model may be modified to provide further efficiencies.

In particular, in some embodiments data may be filtered out or interpolation techniques may be used to increase the speed with which a computer device can execute computer-executable instructions that implement the models.

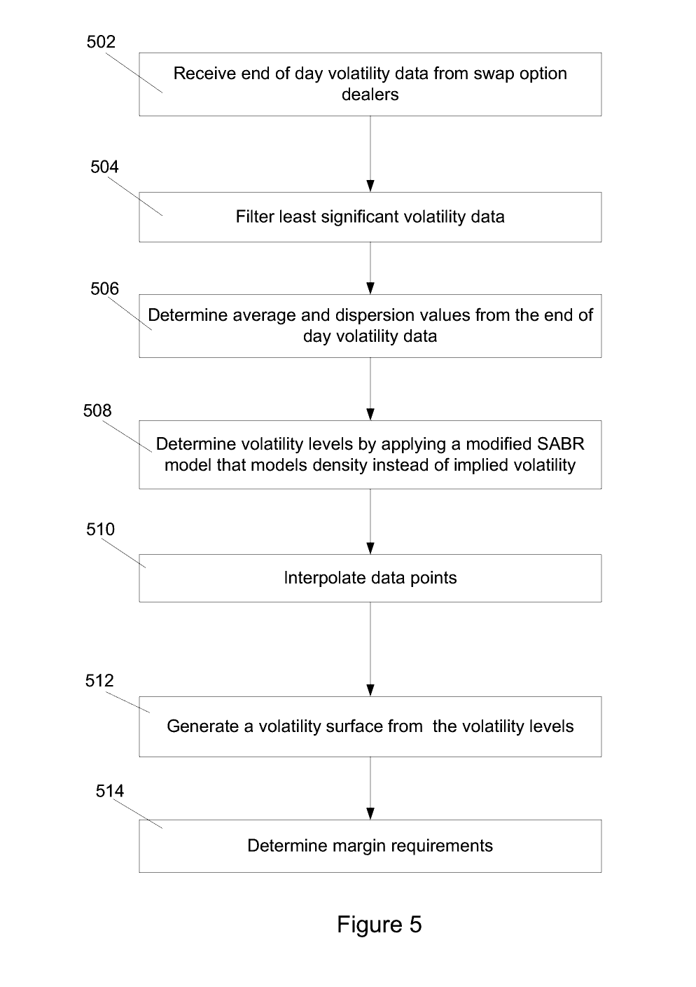

FIG. 5 illustrates a method that may be used to determine volatility levels of swaptions in accordance with an embodiment of the invention. The volatility levels may be used to determine prices and margin requirements. First, in step 502 end of day volatility data is received from swaption dealers. In some embodiments the data may be received from sources in addition to or instead of swaption dealers. The end of day volatility data may include data for swaptions having multiple expiry, tenor and moneyness. The data may include skew normal/log-normal volatility, and prices. Alternative embodiments of the invention may use data determined at times other than end of day.

After the volatility data is received, in step 304 least significant volatility data may be filtered. Filtering data can result in a computer implementing the rest of the process shown in FIG. 5 operating more efficiently and quickly. Filtering may include determining which submissions are most correct and discarding the others. In some embodiments strikes with small Greek values for out of the money (OTM) positions may be discarded. Black-Sholes Delta values can be used as a Greek measure.

In step 506 average and dispersion values from the end of day price data may be determined. Step 506 may include using the data filtered and interpolated in steps 504 and 506.

Next, in step 508 volatility levels may be determined by applying a modified SABR model that models density instead of implied volatility. The modified SABR model may be similar to or the same as modified SABR models described in this document.

In step 510, interpolation between volatility data points may be performed. A clearinghouse computer system may use linear interpolation, or other interpolation on parameters to generate the parameters for pairs between the most liquid tenor/expiry points. The use of interpolation may increase the speed at which a computer device can perform calculations. In some embodiments a clearinghouse computer system may also perform linear interpolation or other interpolation on variance of the parameters.

Once the volatility levels have been determined, a volatility surface may be generated in step 512. Of course, multiple surfaces may be created or the volatility levels may be used to create other types of charts, or may be used in other calculations.

In step 514, volatility levels may be used to determine margin account requirements. The margin account requirements may be initial margin account requirements and/or maintenance margin account requirements.

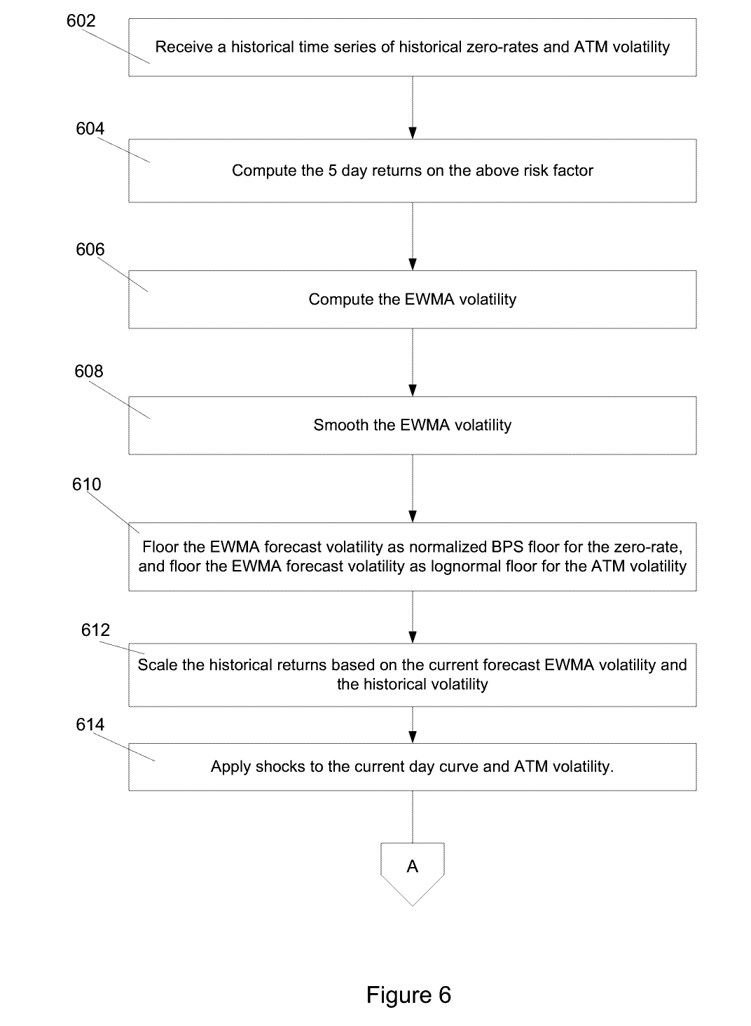

FIG. 6 illustrates an exemplary method for determining margin requirements in accordance with an embodiment of the invention. First, in step 602 a historical time series of historical zero-rates and ATM volatility are received. The historical data may be for a 5 year period. Next, five day returns are computed on the above risk factors in step 604. The EWMA volatility is computed in step 606. In one embodiment EWMA volatility is computed as follows with a standard EWMA formula:

σ_{t,j}²=(1−λ)r_{t-1,j}²+λσ_{t-1,j}²

Where σ is the EWMA volatility and λ is set at 0.97.
In some embodiments absolute return or percentage return may be used instead of log return.

After the EWMA volatility is computed, in step 608 the EWMA volatility may be smoothed. The data may be smoothed using a 10 day moving average for the zero-rate factor. In some embodiments no smoothing is applied to the EWMA volatility for the ATM Volatility factor (IP). Next, in step 610 the process floors the EWMA forecast volatility as normalized BPS floor for the zero-rate and floors the EWMA forecast volatility as lognormal floor for the ATM volatility. A log-normal volatility floor may be applied for the volatility factor (IP). The historical returns may be scaled based on the current forecast EWMA volatility and the historical volatility in step 612 and shocks may be applied to the current day curve in step 614.

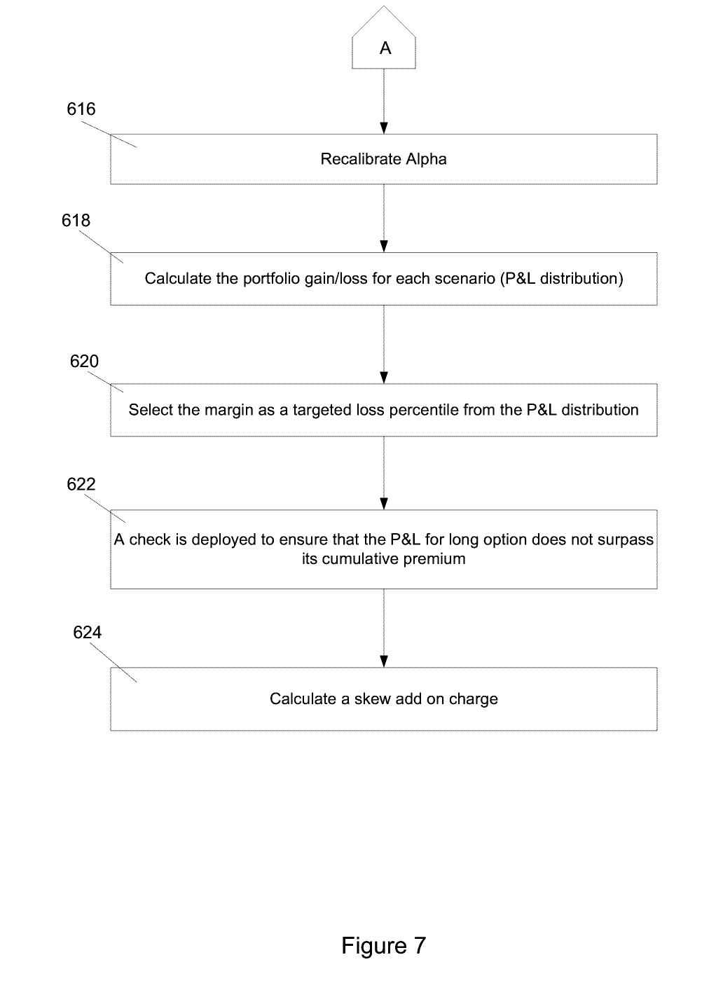

FIG. 7 shows the continuation of the method started in FIG. 6. In step 616 alpha is recalibrated. In various embodiments the inputs to the modified SABR model that is used to price swaptions are ATM forward Rate, Nu1, Nu2, Alpha and Beta. Alpha may be recalibrated for the shock scenarios using scaled ATM volatility and forward rates as derived from the scenario curves (scaled zero rates). The Nu1 and Nu2 parameters for the shock scenarios may be the same as the base scenario (IP).

Shocked scenarios may be used to estimate the effects of stressed markets on the IRS and swaptions market. A clearinghouse computer system or other computer system calculates shocked rate/vol scenarios using a coefficient to scale the returns calculated above. For each risk factor/scenario the forecasted volatilities (smoothed and floored as described in the steps above), a scaling coefficient may then be computed by dividing it by the historical EWMA volatility of that tenor/scenario. This coefficient may scale the scenario-return up if the forecasted EWMA is higher than that scenario's historical volatility and down if the forecasted EWMA volatility is lower than that scenario's historical volatility.

$$\text{?} = \frac{\text{?}}{\text{?}}$$

$$\text{?} \text{indicates text missing or illegible when filed}$$

### Where,

c is the scaling coefficient

σ_{T,j}^{EWMA} is the forecasted EWMA volatility after smoothing and flooring

σ_{t,j} [symbol] is the historical EWMA volatility as of time t after smoothing

Scenario forward may be floored in the case it becomes negative. Additional capping for scenario ATM volatilities may be applied to avoid unrealistic scenarios. In some situations, the scenario forward is relatively too low when compared to the scenario ATM volatility. This can result in unrealistic scenarios and in unstable calibration. Scenario ATM volatilities may be capped proportionally to scenario forward. This results from the approximation that the implied normal volatility is roughly forward times implied lognormal volatility, i.e. implied lognormal volatility is capped.

Using the scaling coefficient, α may be recalibrated for the shock scenarios using scaled ATM volatility and forward rates. The v₁ and v₂ parameters may remain the same for the shock scenario as for the base scenario.

Next, in step 618 the portfolio gain/loss is calculated for each scenario (P&L distribution). The margin as a targeted loss percentile from the P&L distribution may be selected in step 620.

A check may be deployed to ensure that the P&L for long option does not surpass its cumulative premium i.e. long option value in step 622. Step 622 may also ensure that the maximum offset provided by a long position in a portfolio consisting of long and short does not surpass the long option value→asymmetric margins. Finally, step 624 a skew add on charge may be calculated. In some embodiments step 624 is performed before step 622. An exemplary method for calculating a skew charge is described below.

The sensitivity of the portfolio to Nu1 and Nu2 may be computed. The skew charge for each scenario may be computed as:

$$Skew {Charge}_{i} = \frac{d F}{d {Nu}_{1}} * {Nu}_{1} + \frac{d F}{d {Nu}_{2}} * {Nu}_{2}$$

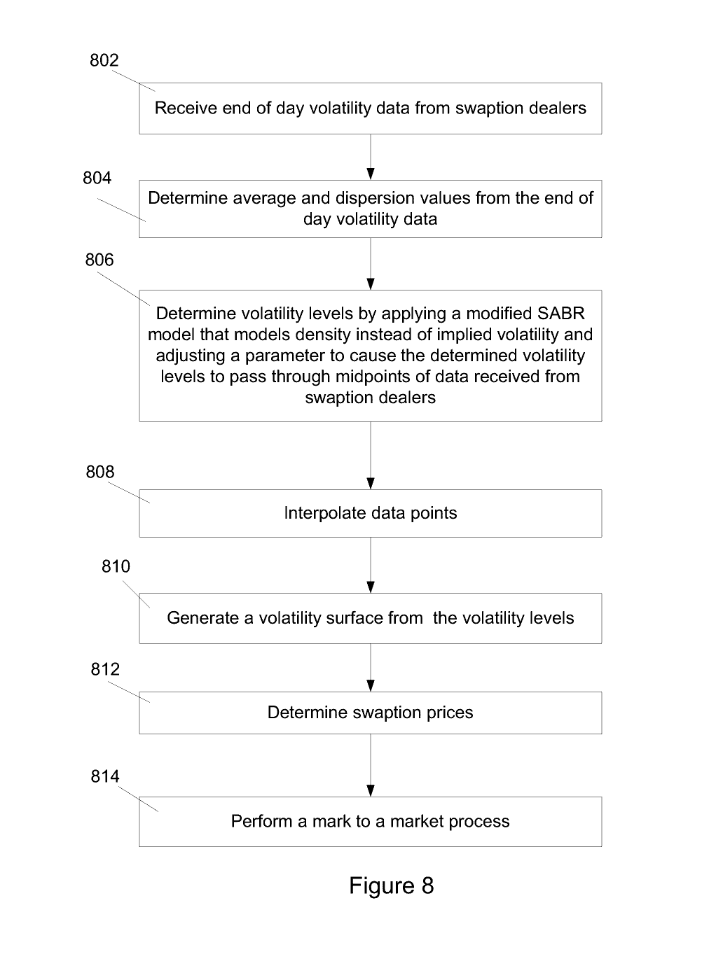

The skew scenarios may be identified as the 4^{th} worst case loss of five day changes for Nu1 and Nu2 based on historical data only. An indicator for these scenarios may include large parallel moves for a particular tenor and expiry pair, spread and butterfly type moves across the tenor and expiry pairs. A clearinghouse or other entity may add on a few hypothetical but feasible scenarios to capture moves not reflected in historical data. The skew add on charge may then be sampled as the worst case loss from the above distribution. FIG. 8 illustrates a method that may be used to determine volatility levels of swaptions in accordance with an embodiment of the invention. In step 802 end of day volatility data is received from swaption dealers. As mentioned above, in some embodiments the data may be received from sources in addition to or instead of swaption dealers and may be for other time periods. The end of day volatility data may include data for swaptions having multiple expiry, tenor and moneyness. The data may include skew normal/log-normal volatility, and prices.

In some embodiments of the invention, the shocked curves may be used to calculate the portfolio value under each scenario. Using this, the P/L for each may be calculated against the base scenario. The P&L distribution may be sorted from maximum gain to maximum loss. A total loss associated with a targeted confidence value, such as 99.7, may be identified.

$${M}^{+} = P \& \text{?} , {M}^{-} = P \& \text{?}$$

$$\text{?} \text{indicates text missing or illegible when filed}$$

Where,
M⁻ is the margin for a given portfolio;
M⁻ is the margin for the portfolio with exactly opposite trades

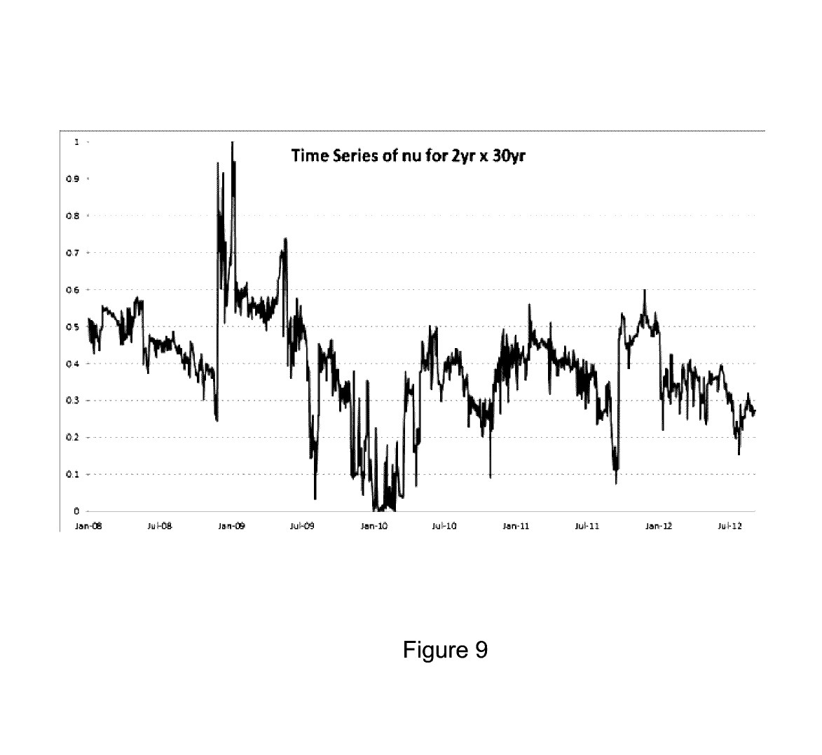

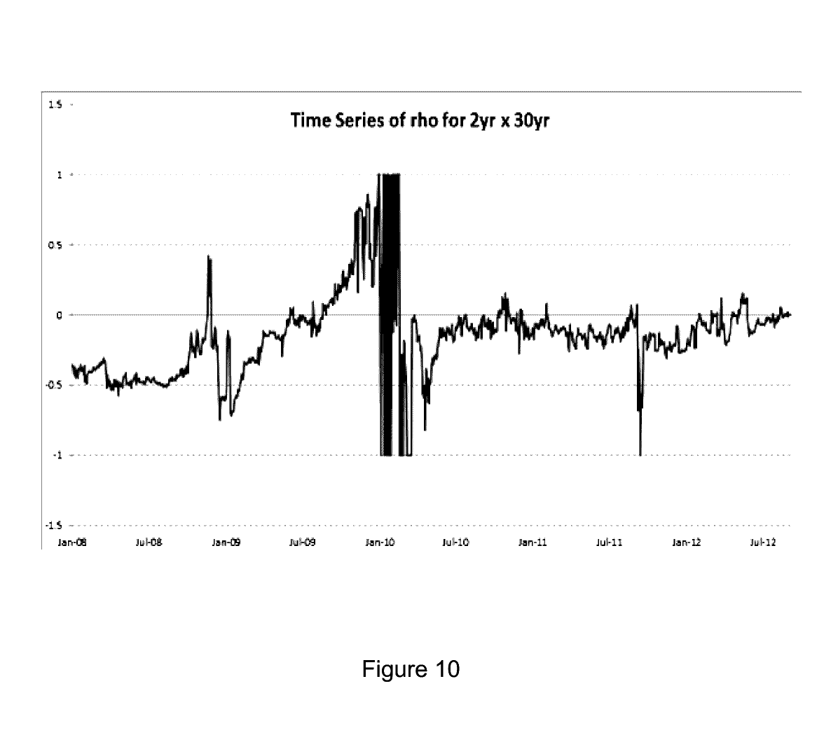

In some embodiments of the invention, ν may be used to capture skew risks. As ν decreases to lower numbers, ρ becomes unstable and oscillates wildly until ν returns to a more normal value. FIG. 9 shows the low ν values and FIG. 10 shows the extreme fluctuation in ρ in response.

Low is a result of a market with very low volatility of volatility (“vol of vol”). Low ν can also cause the ρ factor to become irrelevant to pricing and unstable during calibrations. This may result in the SABR model over-parameterized during certain periods of low volatility. In accordance with some embodiments of the invention, modifications to a SABR model skew parameters may be made to address over-parameterization. In particular, two new parameters ν₁ and ν₂ may be used. As shown below, ν₁ and ν₂ may be considered orthogonal transformations of existing SABR parameters.

Using the S,z,α,β,ν,ρ, W₁ and W₂ defined for the SABR model described in the SABR Model above, the ν and ρ factors are converted to ν₁ and ν₂ in the following formula:

$$dS = z {αS}^{F} d {\overline{W}}_{1}$$

$$dz = z * ( v ρ d {\overline{W}}_{1} + v \sqrt{1 - {ρ}^{2}} d {\overline{W}}_{2} )$$

$$Where \text{:}$$

$${v}_{1} = v ρ$$

$${v}_{2} = v \sqrt{1 - {ρ}^{2}}$$

$$d {\overline{W}}_{1} = d {W}_{1}$$

$$d {\overline{W}}_{2} = \frac{- ρ}{\sqrt{1 - {ρ}^{2}}} {dW}_{1} + \frac{1}{\sqrt{1 - {ρ}^{2 }}} {dW}_{2}$$

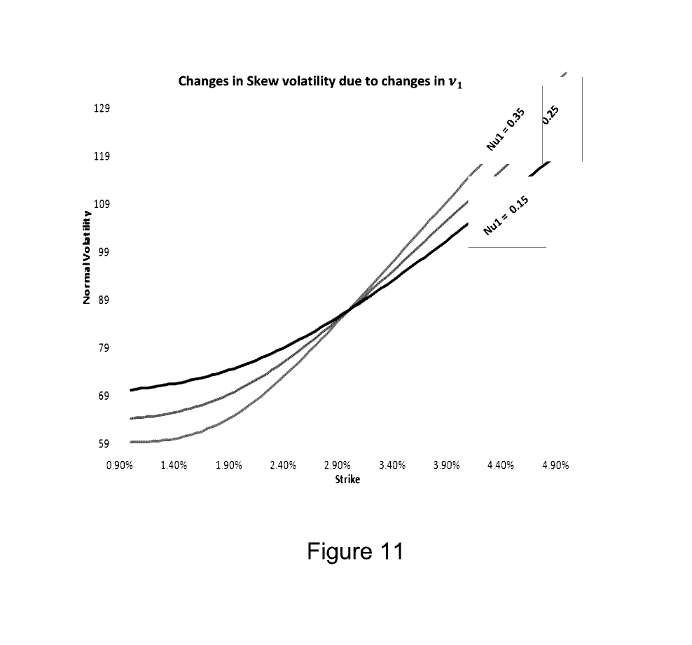

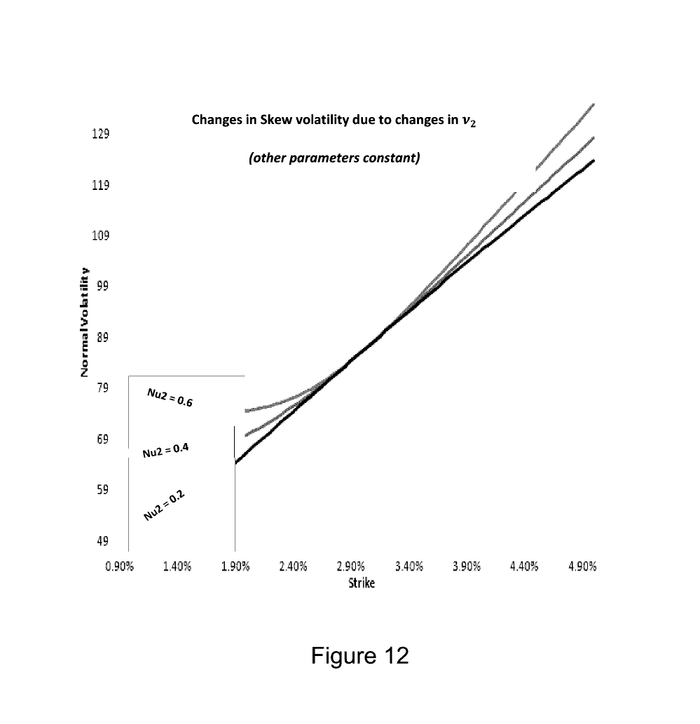

FIG. 11 shows the effective of ν₁ on the slope of the implied volatility, similar to ρ. FIG. 12, similar to the original ν, shows the impact of changing ν₂ on the curvature.

The jumps observed in the volatility and correlations in the skews could pose modeling concerns if the skew is included inside a standard scaled HVaR calculation, which is typically based on a pre-defined lookback period and relies greatly on the behavior of implied tail correlations. Therefore, in some embodiments of the invention, a clearinghouse computer system or other computer system may determine and consider skew as a separate charge for margin calculations and provide for no correlation benefits against rate returns or at the money volatility returns.

Various embodiments of the invention may use other processes to capture skew risks. In one embodiment skew risk is included inside the HVaR calculation and no additional add-on is calculated. The skew risk may be captured by using the synchronized ν₁,ν₂ returns for each scenarios. The skew risk may then be modeled inside the HVaR simulation, together with rates and at the money volatilities, by adding ν₁,ν₂ as additional risk factors into the HVaR simulation. Returns for ν₁,ν₂ risk factors are calculated without EWMA scaling i.e. ν₁,ν₂ returns are not scaled.

In another embodiment, skew risk is calculated as an additional add-on. In order to capture the skew risk, an add-on charge is computed based on combinations of theoretical and historical scenarios as observed in the market i.e. based on risk-reversal and butterfly. In order to capture the risk across different moneyness, scenarios are generated for risk-reversals and butterfly at different moneyness, such as 25, 50, 75, and 100 BPS moneyness independently i.e. scenarios determined using one moneyness point are then interpolated or extrapolated for other moneyness. Next, a clearinghouse computer system or other computer system moves the changes in risk-reversals and butterfly due to changes in at the money volatility and zero rates from the actual move. A skew add-on may then be generated by applying risk reversal and butterfly scenarios, recalibrating to generated modified SABR parameters, generating trades PnL, and sampling the worst loss. The resulting value may then be checked to ensure that the P/L for long option does not surpass its cumulative premium i.e. long option value. Long only positions cannot provide any more offsets or lose more than its base price (aka premium). The value may be checked to ensure that the P/L for Short Option does not give offset benefit more than its corresponding long options value too.

After the volatility data is received, in step 804 average and dispersion values from the end of day volatility data may be determined. Step 804 may include blending data received from multiple sources at multiple strike prices.

Next, in step 806 volatility levels may be determined by applying a modified SABR model. The modified SABR model may model density instead of implied volatility and may include adjusting a parameter to cause the determined volatility levels to pass through midpoints of data received from swaption dealers.

Step 806 may include first using a SABR model first calibrated to all the market quotes. SABR models generally include parameters α, β, ν, ρ. First parameter, α, is responsible for fitting ATM volatility. The second parameter, β, may be a fixed number. The last two parameters are responsible for fitting the skew and smile of market quotes. In one embodiment, the alpha parameter is implied while keeping the other two parameters, ν, ρ, unchanged. The implied alpha parameter may be determined by solving the equation

P(K)−P_{SABR}(α_{K},K,ν,ρ)

with respect to the implied alpha parameter α_{K}. Here P(K) is the swaption value (either call or put) at the strike K and P_{SABR}(α_{K},K,ν,ρ) is a modified SABR pricing formula. This formula may be resolved for swaption expiry and tenor, which results in a three dimensional surface of the SABR parameters. The modified SABR model may weight each moneyness with a weight inversely proportional to the dispersion of data received from the swaption dealers. The modified SABR model may be used to fit a smile curve to mid-market values.

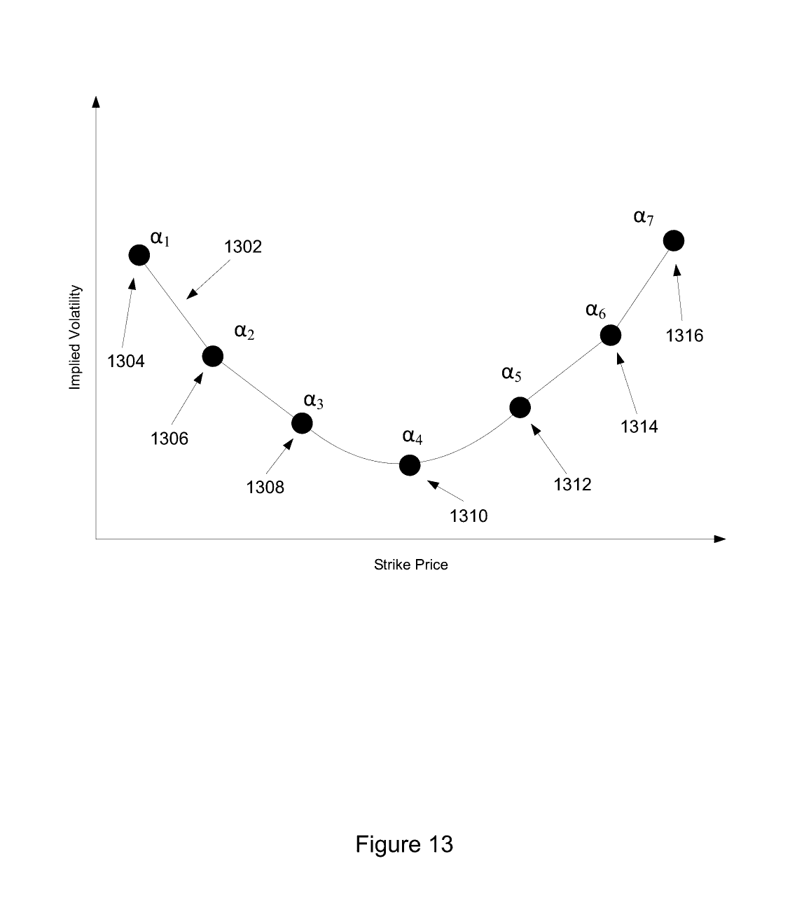

FIG. 13 illustrates an exemplary volatility smile 1302 created with the process shown in FIG. 8. Points 1304-1316 represent average or blended data points received from swaption dealers or other sources. As is shown, each point includes an implied a parameter, which causes volatility smile 1302 to pass through midpoints of data points 1304-1316.

In step 808, interpolation between volatility data points may be performed. A clearinghouse computer system may use linear interpolation, or other interpolation on parameters to generate the parameters for pairs between the most liquid tenor/expiry points. The use of interpolation may increase the speed at which a computer device can perform calculations. In some embodiments a clearinghouse computer system may also perform linear interpolation or other interpolation on variance of the parameters.

Once the volatility levels have been determined, a volatility surface may be generated in step 810. Of course, multiple surfaces may be created or the volatility levels may be used to create other types of charts, or may be used in other calculations.

Once the volatility levels have been determined, swaption prices may be determined in step 812 and in step 814 a mark to market process may be performed. The process shown in FIG. 8 may also be used to set initial margin account requirements and/or maintenance margin account requirements.

Another embodiment of the invention includes adjusting a cumulative probability density function (CDF) of a baseline model to determine a volatility smile. This embodiment may be applicable to situations where non-arbitrage interpolation is required. The well-known formula for pricing a European call option on the underlying X:

$${P}_{c} ( K ) = {\int }_{- ∞}^{K} d xp ( X ) {( X - K )}^{+}$$

Here P_{c} is the value of the European call p(X) is the probability density of the underlying at the option maturity, and K is the strike. Similar relation exists in the case of a put price.

The cumulative probability density (CDF) is calculated using:

$$C D F ( K ) = {\int }_{- ∞}^{K} d S p ( S ) .$$

The price of a call option can as well be represented in terms of the cumulative probability density as:

$${P}_{v} ( K ) = {\int }_{- ∞}^{K} d S C D F ( S ) d S . \qquad ( 1. )$$

The process starts with a calibrated modified SBAR model or another model that produces a base line fit within an acceptable tolerance. The base cumulative density is denoted by CDF_{BASE}(S). Base CDF, being inserted in (1) may not be exactly consistent with market option prices. It is desirable to resolve the construct CDF(S) consistent with market quotes for all available strikes.

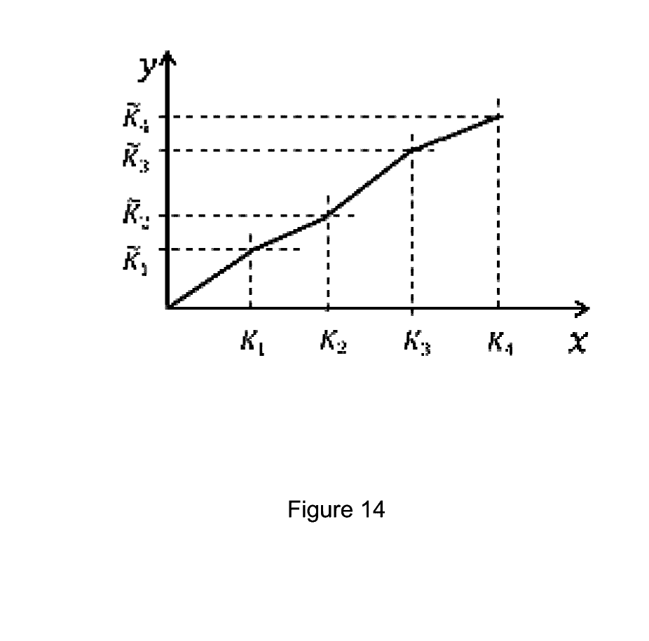

A cumulative probability density CM as

$$C D F ( x ) ≡ {CDF}_{BASE} ( y ( x ) ) ,$$

where y(x) is piece linear function, as shown in FIG. 14. The function shown in FIG. 14 is fully settled by the adjusted values of strikes \tilde{K}₁,\tilde{K}₂, . . . , \tilde{K}_{N}.

From Eq. (1) one can get that:

$${P}_{c} ( {K}_{i + 1} ) - {P}_{c} ( {K}_{i} ) = \frac{{K}_{i + 1} - {K}_{i}}{{K}_{i + 1} - {K}_{i}} \text{?} {CDF}_{BASE} ( x ) d x . \\ \text{?} \text{indicates text missing or illegible when filed} \qquad ( 2 )$$

This equation can be resolved by the method of bootstrapping. Indeed, assuming that \tilde{K}₁ is known, one can find \tilde{K}ᵢ₊₁ from Eq. (2) with the help of a one dimensional solver, since \tilde{K}ᵢ₊₁ is the only unknown. Solving Eq. (2) step by step starting from ATM quote one can find all adjusted strikes that are larger than the ATM strike. Adjusted strikes below the ATM strike can be found accordingly, based on the prices of put options. The above described procedure allows for the construction of the cumulative density that is consistent with market quotes. Interpolated quotes can be determined from Eq. (1). By construction, an increasing cumulative probability density corresponds to positive probability density. This, in turn, means that the method produces an arbitrage free interpolation.

The selection of which one of the models described above may be a function of the ultimate use of the model and processing capabilities of a processor that will be used to carry out a process using the model. For example, when performing a mark to market process a model that strictly fits data may be used and when performing a margin requirement determination a model that less strictly fits data may be used. Margin requirements may include an additional amount to account for models that less strictly fit data. Some computer-implemented processes may use algorithms that use interpolation, data filtering or other steps to allow a computer device programmed with one of the computer-implemented algorithms to efficiently and quickly determine and communicate pricing, volatility and margin requirements.

Some embodiments of the invention include systems and method for calculating the sensitivity of a. portfolio PV to each skew parameter. In one embodiment, sensitivity of a portfolio PV (P) to each ν₁,ν₂ parameter may calculated under the base market condition using the trade information as they are.

In another embodiment sensitivity of portfolio PV (P) to each ν₁,ν₂ parameter may be calculated under the base market condition using adjusted trade information. Using the scenario data which drives the HVaR Margin, moneyness level may be calculated per trade. The trades' strikes can then be changed so that the moneyness levels under base market condition are the same as the ones calculated under scenario condition.

In yet another embodiment sensitivity of portfolio PV (P) to each ν₁,ν₂ parameter may be calculated under the scenario market condition using the trade information as they are. The scenario used here may be the scenario that drives the HVaR Margin. Some further embodiments may use various combination of the above 3 methods and may use the maximum of results from each method.

This determined value may be checked to ensure that the P/L for Long Option does not surpass its cumulative premium i.e. Long Option Value. Long only positions cannot provide any more offsets or lose more than its base price (aka premium). The value may also be checked to ensure that the P/L for Short Option does not give offset benefit more than its corresponding Long Options Value too. The equations below illustrate this construct:

Total Loss=HBaR Loss+Skew Loss

Total Loss−PV_{Scenario t}−PV_{Base}

Assume in scenario i used above, the rates movements and ATM volatilities movements are the same as the scenario that drives the HVaR Margin:

$$Skew Loss = {PV}_{Scenario i} - {PV}_{Base} - HVaR Loss = {PV}_{Base} - HVaR Loss + ( Intrinsic {Value}_{Scenario i} + Option {Value}_{Scenario i} )$$

For Long Option

Skew≧−PV_{Base}−HVaR Loss+Intrinsic Value_{Scenario t}≧−PV_{Base}−HVaR Loss+(Intrinsic Value_{Scenario t}+Q)=−PV_{Base}−HVaR Loss+(Intrinsic Value_{Scenario t}+Q)

Equivalently:

Skew Charge=−Skew Loss

Skew Charge≦PV_{Base}+HVaR Loss−Intrinsic Value_{Scenario t}Skew Charge≦PV_{Base}−HVaR Margin−Intrinsic Value_{Scenario t}

For Short Option

Skew Loss≦−PV_{Base}−HVaR Loss+Intrinsic Value_{Scenario t}

Equivalently:

Skew Charge=Skew Loss

Skew Charge≧PV_{Base}+HVaR Loss−Intrinsic Value_{Scenario t}Skew Loss≦−PV_{Base}−HVaR Loss+Intrinsic Value_{Scenario t}

This will ensure that the maximum offset provided by a long position in a portfolio consisting of Long and Short does not surpass the Long Option Value.

As described above, in some embodiments strike-specific α may be calculated for variation margin and settlement processes. Margin calculations may use a “strike-independent-α” for it modified SABR margin calculation. Using strike-dependent α in the initial margin calculations may result in an extreme increase in risk factors used, potentially resulting in unstable or inaccurate modeling. However, capturing these differences, minor though they are, may ensure an exact fit of the model, improving model performance. These dispersions may be accounted for in a skew add-on charge, through a component called the valuation uncertainty margin, or VUM, which is included in the skew add-on charge.

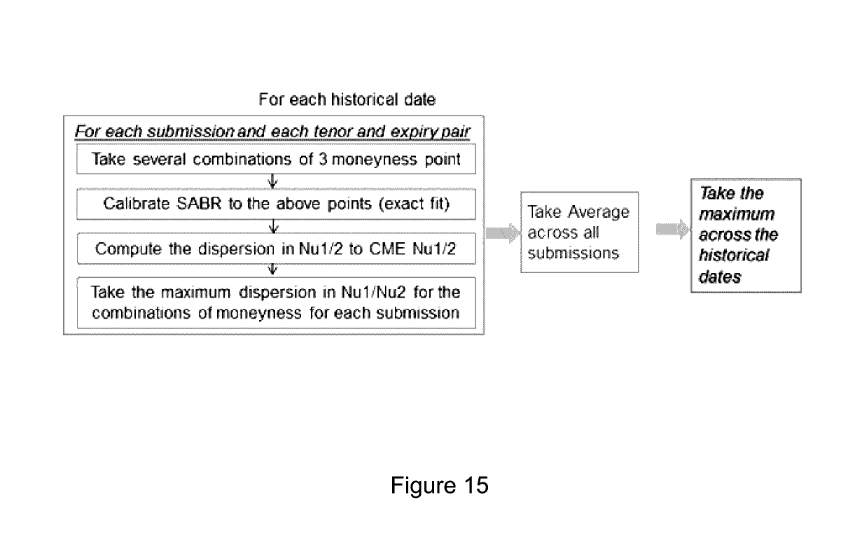

VUM may be determined by calibrating the large dispersions observed to the defined skew scenarios and further scaling those skew scenarios. The calibration determines the appropriate scalar for the skew scenarios to account for the dispersions. Calibration may be a multi-step process. First skew parameters are generated for each day in the historical look back period, for each tenor and expiry pair. To ensure an exact fit, multiple combinations of three moneyness points can be used. Next, the dispersions are defined for each submission as the maximum difference between baseline parameters and parameters generated in the first step. The average dispersion may then be calculated across submissions for a given historical date. The skew scenarios described above may then be scaled to account of the worst dispersions across the historical lookback period for each tenor and expiry pair. Using Skew Scenarios to capture VUM transfers the uncertainty/dispersion of volatility levels to the uncertainty/dispersion of the Skew parameters ν₁,ν₂. FIG. 15 illustrates a process that may be used to calculate a valuation uncertainty margin, in accordance with an embodiment of the invention.

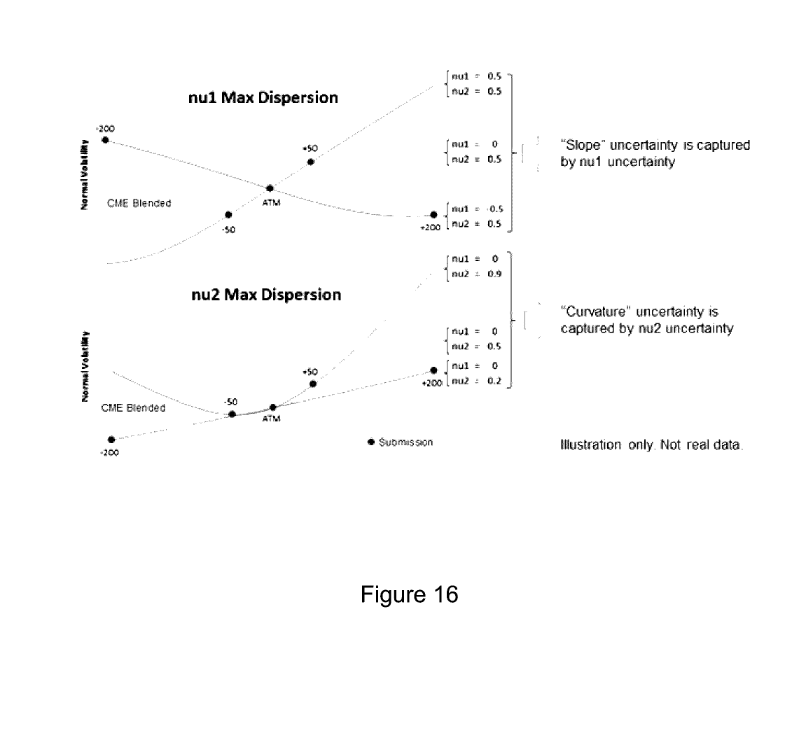

As shown in FIG. 16, using skew scenarios to capture VUM transfers the uncertainty/dispersion of volatility levels to the uncertainty/dispersion of the skew parameters ν₁,ν₂.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. For example, various methods are disclosed herein with steps that are performed in exemplary orders. In alternative embodiments the steps may be performed in other orders without departing from the broader spirit and scope of the invention. All variations and alternative embodiments are considered within the sphere, spirit, and scope of the invention.

1. A computer system comprising:
a processor;
a tangible computer-readable containing computer executable instructions that when executed by the processor cause the computer system to perform the steps comprising:
(a) receiving end of day volatility data from swaption dealers;
(b) filtering the end of day volatility data;
(c) determining average and dispersion values from the filtered end of day volatility data; and
(d) determining volatility levels by applying a modified SABR model that models density instead of implied volatility to the end of day volatility data.

2. The computer system of claim 1, wherein (a) comprises receiving skew normal/log-normal volatility, and price from the swaption dealers.

3. The computer system of claim 2, wherein (a) comprises receiving data for swaptions having multiple expiry, tenor and moneyness.

4. The computer system of claim 1, wherein the modified SABR model weighs each moneyness with a weight inversely proportional to the dispersion of data received from the swaption dealers.

5. The computer system of claim 1, further including:
(e) determining margin requirements.

6. The computer system of claim 5, wherein (e) comprises:
(i) scaling historical returns for current volatility;
(ii) calculating shock scenarios; and
(iii) determining a margin for each shock scenario.

7. The computer system of claim 1, wherein (b) comprises filtering out strikes with small Greek values for out of the money positions.

8. The computer system of claim 7, wherein (b) Black-Sholes Delta comprises one of the Greek values.

9. The computer system of claim 1, further including interpolating volatility data between the received end of day volatility data.

10. The computer system of claim 9, wherein the interpolation comprises linear interpolation.

11. The computer system of claim 1, further including interpolating volatility data between the filtered end of day volatility data.

12. A computer implemented method comprising:
(a) receiving end of day volatility data from swaption dealers;
(b) filtering at a processor the end of day volatility data;
(c) determining at a processor average and dispersion values from the filtered end of day volatility data; and
(d) determining at a processor volatility levels by applying a modified SABR model that models density instead of implied volatility to the end of day volatility data.

13. The computer implemented method of claim 12, wherein (a) comprises receiving skew normal/log-normal volatility, and price from the swaption dealers.

14. The computer implemented method of claim 12, wherein (a) comprises receiving data for swaptions having multiple expiry, tenor and moneyness.

15. The computer implemented method of claim 12, wherein the modified SABR model weighs each moneyness with a weight inversely proportional to the dispersion of data received from the swaption dealers.

16. The computer implemented method of claim 12, further including:
(e) determining margin requirements.

17. The computer implemented method of claim 16, wherein (e) comprises:
(i) scaling historical returns for current volatility;
(ii) calculating shock scenarios; and
(iii) determining a margin for each shock scenario.

18. The computer implemented method of claim 12, wherein (b) comprises filtering out strikes with small Greek values for out of the money positions.

19. The computer implemented method of claim 18, wherein (b) Black-Sholes Delta comprises one of the Greek values.

20. The computer implemented method of claim 12, further including interpolating volatility data between the received end of day volatility data.
